(19) United States
(12) Patent Application Publication
(10) Pub. No.: US 2017/0374212 A1
(43) Pub. Date: Dec. 28, 2017

(54) INFORMATION PROCESSING APPARATUS, INFORMATION PROCESSING SYSTEM, AND IMAGE FORMING APPARATUS

(71) Applicant: FUJI XEROX CO., LTD., Tokyo (JP)

(72) Inventor: Mayumi MAKIYAMA, Kanagawa (JP)

(73) Assignee: FUJI XEROX CO., LTD., Tokyo (JP)

(21) Appl. No.: 15/337,685

(22) Filed: Oct. 28, 2016

(30) Foreign Application Priority Data
Jun. 23, 2016 (JP) 2016-124494

(51) Int. Cl. H04N 1/00; G06F 3/01

(52) U.S. Cl. CPC H04N 1/00437; H04N 1/00474; G06F 3/013; H04N 1/00411; H04N 2201/0094

(57) ABSTRACT

An information processing apparatus includes a display, an operating unit, and a controller. The display displays in a form of a display image a list of plural functions relating to the information processing apparatus. The operating unit accepts a selecting operation in which a user selects his or her target function from the list of the plural functions. The controller performs control so that the list of the plural functions includes a function or functions relating to a position in a line of sight of the user.

### CROSS-REFERENCE TO RELATED APPLICATIONS

This application is based on and claims priority under 35 USC 119 from Japanese Patent Application No. 2016-124494 filed Jun. 23, 2016.

### BACKGROUND

### (i) Technical Field

The present invention relates to an information processing apparatus, an information processing system, and an image forming apparatus.

### (ii) Related Art

In some cases, displays of information processing apparatuses display in the form of a display image a list of functions relating to apparatuses that includes the displays. In a typical method in such cases, the user selects a target function from the list.

### SUMMARY

According to an aspect of the present invention, an information processing apparatus includes a display, an operating unit, and a controller. The display displays in a form of a display image a list of plural functions relating to the information processing apparatus. The operating unit accepts a selecting operation in which a user selects his or her target function from the list of the plural functions. The controller performs control so that the list of the plural functions includes a function or functions relating to a position in a line of sight of the user.

### BRIEF DESCRIPTION OF THE DRAWINGS

Exemplary embodiment of the present invention will be described in detail based on the following figures, wherein:

FIG. 1 illustrates an information processing system according to an exemplary embodiment;

FIG. 2 is the appearance of an image forming apparatus according to the present exemplary embodiment;

FIG. 3 illustrates an internal structure of the image forming apparatus according to the present exemplary embodiment;

FIG. 4 is an example of a display image displayed in the user interface;

FIG. 5 is a block diagram illustrating an example of a functional configuration of a control device;

FIG. 6 is a flowchart illustrating a first example of operations of the control device;

FIG. 7 illustrates an example of a list of functions displayed in a user interface when the position watched by the user is a document transport unit;

FIG. 8 illustrates an example of a list of functions displayed in the user interface when the position watched by the user is a manual feed tray;

FIG. 9 is a flowchart illustrating a second example of the operations of the control device; and

FIG. 10 is an example of a display image displayed in the user interface according to the second example.

### DETAILED DESCRIPTION

An exemplary embodiment will be described in detail below with reference to the accompanying drawings.

### Description of an Overall Structure of an Information Processing System

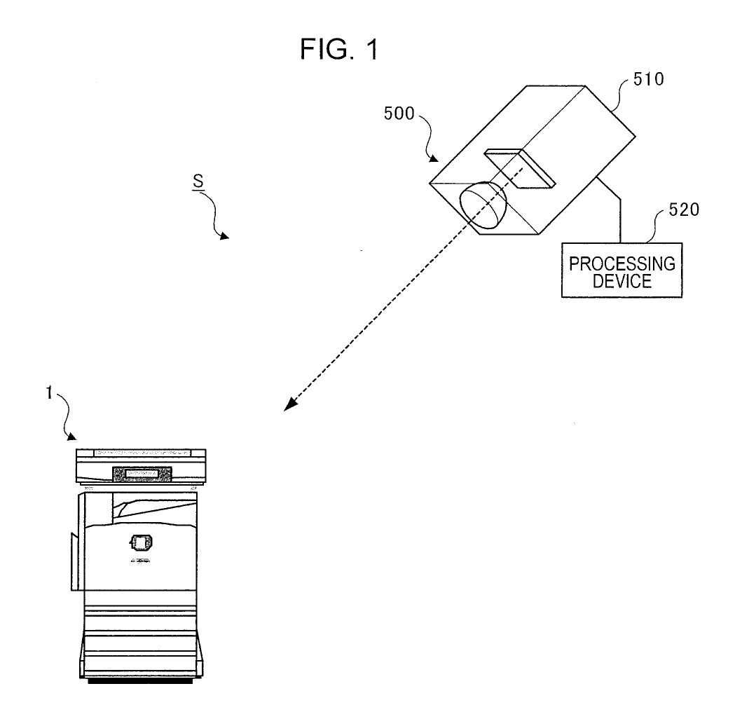

FIG. 1 illustrates an information processing system according to an exemplary embodiment.

As illustrated in FIG. 1, an information processing system S includes a detection device 500 and an image forming apparatus (information processing apparatus) 1. The detection device 500 serves as an example of a detector that detects a line of sight of a user. The image forming apparatus 1 forms an image on a recording material.

### Description of the Detection Device 500

The detection device 500 includes a camera 510 and a processing device 520. The camera 510 is used to take an image of the user. The processing device 520 obtains the line of sight of the user in accordance with the image taken by the camera 510.

The camera 510 includes, for example, an optical system and an image sensor. The optical system converges light incident thereupon. The image sensor is an imaging device that detects the light having been converged by the optical system.

The optical system includes a single lens or plural lenses combined with one another. Various types of aberrations are eliminated by a combination of the lenses, coatings provided on the surfaces of the lenses, and so forth. The image sensor includes imaging elements such as charge coupled devices (CCDs) or complementary metal oxide semiconductors (CMOSs) arranged therein.

The processing device 520 analyzes the image taken by the camera 510 and detects the line of sight of the user in accordance with the analysis of the image. Here, the line of sight of the user refers to, for example, information about what is a target watched by the user, and furthermore, includes, for example, information about the size of the pupil, information about whether or not the user intensely watches the target, and so forth.

The processing device 520 extracts, for example, parts of the user such as the face and the eye from the image taken by the camera 510 and detects the line of sight of the user in accordance with the orientation of the face, the position of the pupil in the eye, and the like.

### Description of an Overall Structure of the Image Forming Apparatus 1

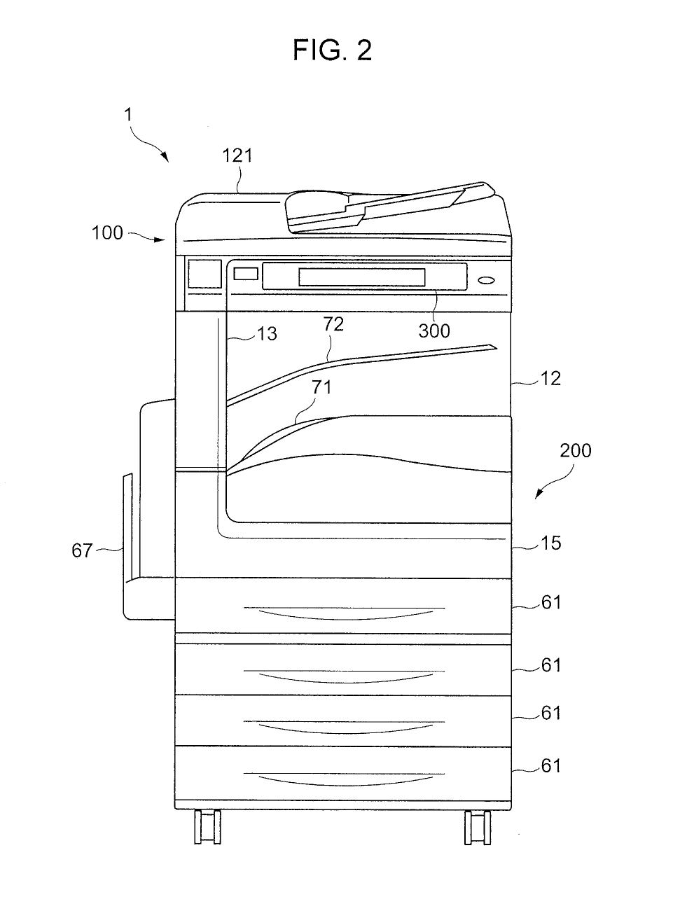

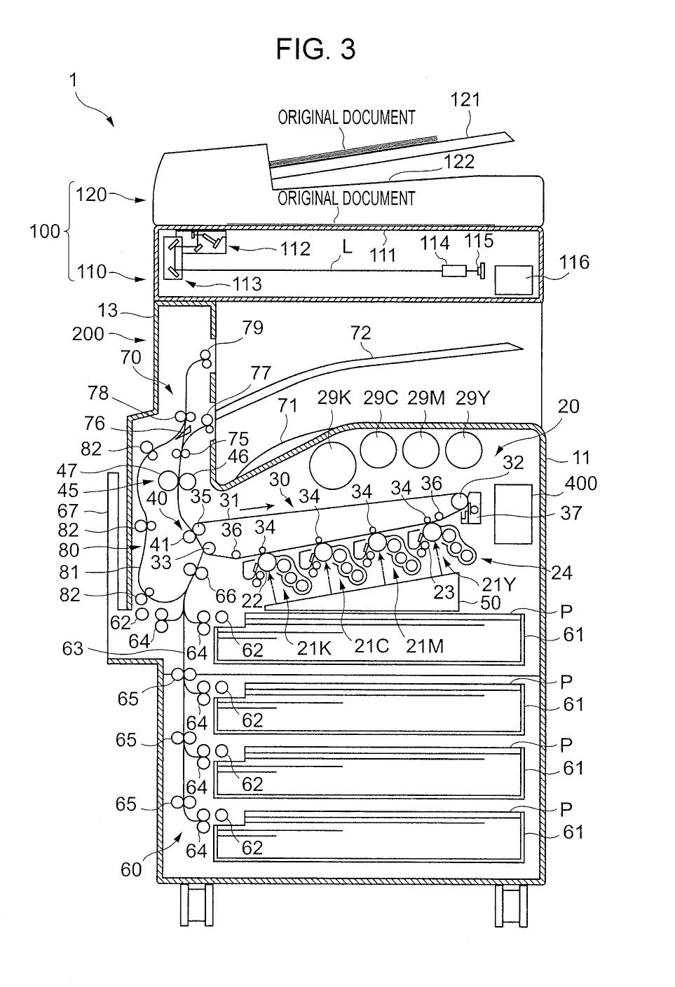

FIG. 2 is the appearance of the image forming apparatus 1 according to the present exemplary embodiment. FIG. 3 is an internal structure of the image forming apparatus 1 according to the present exemplary embodiment.

The image forming apparatus 1 includes an image reading device 100 that reads an image on an original document and an image recording device 200 that records the image on the recording material (“recording material” is also representatively referred to as “sheet P” hereafter. Also, “sheet P” is described in the plural form “sheets P” where appropriate). Furthermore, the image forming apparatus 1 includes a user interface (UI) 300 that accepts operating input performed by the user and displays various types of information for the user. Furthermore, the image forming apparatus 1 includes a control device 400 that controls operations of the entirety of the image forming apparatus 1.

The image reading device 100 is disposed on an upper portion of the image forming apparatus 1. The image recording device 200 is disposed below the image reading device 100. The control device 400 is disposed in the image recording device 200. The user interface 300 is disposed in an upper central portion on the front side of the image processing apparatus 1, that is, on the front side of a central portion of an image reading unit 110, which will be described later, of the image reading device 100.

First, the image reading device 100 is described.

The image reading device 100 includes the image reading unit 110 that reads the image of the original document and a document transport unit 120 that transports the original document to the image reading unit 110. The document transport unit 120 is disposed in an upper portion of the image reading device 100. The image reading unit 110 is disposed in a lower portion the image reading device 100.

The document transport unit 120 includes a document loader 121 and a document output unit 122. The document loader 121 contains the original document. The original document transported from the document loader 121 is output to the document output unit 122. Thus, the original document is transported from the document loader 121 to the document output unit 122. The document transport unit 120 is also referred to as an auto document feeder (ADF).

The image reading unit 110 includes a platen glass 111, a light radiation unit 112, a light guide unit 113, and an imaging lens 114. The light radiation unit 112 radiates light toward a target side (image side) of the original document. The light guide unit 113 guides light L radiated by the light radiation unit 112 toward the target side of the original document and reflected at the target side of the original document. The imaging lens 114 focuses an optical image of the light L guided by the light guide unit 113. Furthermore, the image reading unit 110 includes a detection unit 115 and an image processing unit 116. The detection unit 115 includes a photoelectric converter such as a CCD image sensor that photoelectrically converts the light L having been focused by the imaging lens 114, so that the detection unit 115 detects the focused optical image. The image processing unit 116 is electrically connected to the detection unit 115, so that an electric signal as image information obtained by the detection unit 115 is transmitted to the image processing unit 116.

The image reading unit 110 reads an image of the original document transported by the document transport unit 120 and an image of the original document placed on the platen glass 111.

Next, the image recording device 200 is described.

The image recording device 200 includes an image forming section 20, a sheet feed unit 60, a sheet output unit 70, and an inversion transport unit 80. The image forming section 20 forms an image on the sheet P. The sheet feed unit 60 feeds the sheet P to the image forming section 20. The sheet output unit 70 outputs the sheet P on which the image has been formed by the image forming section 20. The inversion transport unit 80 inverts the sheet P on one side of which the image has been formed by the image forming section 20 while transporting again the sheet P toward the image forming section 20.

The image forming section 20 includes four image forming units 21Y, 21M, 21C, and 21K for yellow (Y), magenta (M), cyan (C), and black (K). The image forming units 21Y, 21M, 21C, and 21K are arranged parallel to one another and spaced from one another with a certain distance set therebetween. The image forming units 21 include respective photosensitive drums 22, respective chargers 23, and respective developing devices 24. The chargers 23 uniformly charge the surfaces of the respective photosensitive drums 22. The developing devices 24 each develop an electrostatic latent image formed by laser radiation performed by an optical system unit 50, which will be described later, with toner of a corresponding one of predetermined color components so as to make visible the electrostatic latent image. Furthermore, the image forming section 20 is provided with toner cartridges 29Y, 29M, 29C, and 29K that supply toner of the colors to the developing devices 24 of the respective image forming units 21Y, 21M, 21C, and 21K.

The image forming section 20 includes the optical system unit 50 below the image forming units 21Y, 21M, 21C, and 21K. The optical system unit 50 radiates laser light toward the photosensitive drums 22 of the image forming units 21Y, 21M, 21C, and 21K. The optical system unit 50 includes a semiconductor laser (not illustrated) and a modulator (not illustrated). The optical system unit 50 also includes a polygon mirror (not illustrated), a window (not illustrated) and a frame (not illustrated). The polygon mirror deflects and scans the laser light emitted from the semiconductor laser. The window formed of glass allows the laser light to pass therethrough. The frame tightly encloses the elements of the optical system unit 50.

Furthermore, the image forming section 20 includes an intermediate transfer unit 30, a second transfer unit 40, and a fixing device 45. The intermediate transfer unit 30 performs multi-transfer, through which the toner images of the colors formed on the photosensitive drums 22 of the image forming units 21Y, 21M, 21C, and 21K are transferred onto an intermediate transfer belt 31. The second transfer unit 40 transfers the toner images superposed on the intermediate transfer unit 30 onto the sheet P. The fixing device 45 fixes the toner images formed on the sheet P by applying heat and pressure.

The intermediate transfer unit 30 includes the intermediate transfer belt 31, a drive roller 32, and a tension roller 33. The drive roller 32 drives the intermediate transfer belt 31. The tension roller 33 applies a certain amount of tension to the intermediate transfer belt 31. The intermediate transfer unit 30 also includes first transfer rollers 34 and a backup roller 35. Two or more (four according to the present exemplary embodiment) of the first transfer rollers 34 face the photosensitive drums 22 with the intermediate transfer belt 31 interposed therebetween and transfers the toner images formed on the photosensitive drums 22 onto the intermediate transfer belt 31. The backup roller 35 faces a second transfer roller 41, which will be described later, with the intermediate transfer belt 31 interposed therebetween.

The intermediate transfer belt 31 is looped over plural rotating members including, for example, the drive roller 32, the tension roller 33, the first transfer rollers 34, the backup roller 35, and a driven roller 36. The intermediate transfer belt 31 is rotated in an arrow direction at a predetermined speed by the drive roller 32 rotated by a drive motor (not illustrated). The intermediate transfer belt 31 is formed of, for example, rubber or resin.

The intermediate transfer unit 30 also includes a cleaner 37 that removes residual toner and the like existing on the intermediate transfer belt 31. The cleaner 37 removes the residual toner, paper dust, and the like from the surface of the intermediate transfer belt 31 after the toner images have been transferred.

The second transfer unit 40 includes the second transfer roller 41 provided at a second transfer position. The second transfer roller 41 is pressed against the backup roller 35 with the intermediate transfer belt 31 interposed therebetween so as to transfer the images onto the sheet P through second transfer. The second transfer position is formed by the second transfer roller 41 and the backup roller 35 that faces the second transfer roller 41 with the intermediate transfer belt 31 interposed therebetween. At the second transfer position, the toner images having been transferred onto the intermediate transfer belt 31 are transferred onto the sheet P.

The fixing device 45 fixes onto the sheet P the images (toner images) having been transferred onto the sheet P through the second transfer performed by the intermediate transfer unit 30. This fixing of the images is performed by utilizing heat and pressure with a heating fixing roller 46 and a pressure roller 47.

The sheet feed unit 60 includes sheet containers 61, feed rollers 62, a transport path 63, and transport rollers 64, 65, and 66. The sheet containers 61 contain the sheets P on which images are to be formed. The feed rollers 62 feed sheets P contained in the sheet containers 61. The sheets P fed by the feed rollers 62 are transported through the transport path 63. The transport rollers 64, 65, and 66 are disposed along the transport path 63 so as to transport the sheets P fed by the feed rollers 62 to the second transfer position. The sheet feed unit 60 also includes a manual feed tray 67 that allows the sheets to be manually fed. The manual feed tray 67 is openable. Thus, the manual feed tray 67 is opened when in use so as to allow the sheets P to be set therein and closed when not in use. FIG. 3 illustrates the manual feed tray 67 in a closed state.

The sheet output unit 70 includes a first placement tray 71 and a second placement tray 72. The first placement tray 71 is provided above the image forming section 20 and allows the sheets P on which the images have been formed by the image forming section 20 to be placed thereon. The second placement tray 72 is provided between the first placement tray 71 and the image reading device 100 and allows the sheets P on which the images have been formed by the image forming section 20 to be placed thereon.

The sheet output unit 70 also includes a transport roller 75 and a switching gate 76. The transport roller 75 is provided downstream of the fixing device 45 in a transport direction so as to transport each of the sheets P onto which the toner images have been fixed. The switching gate 76 is provided downstream of the transport roller 75 in the transport direction and switches the transport direction of the sheet P. The sheet output unit 70 also includes a first output roller 77 disposed downstream of the switching gate 76 in the transport direction. The first output roller 77 outputs to the first placement tray 71 the sheet P transported in the transport direction switched to one side (right side of FIG. 3) by the switching gate 76. The sheet output unit 70 also includes a transport roller 78 and a second output roller 79 disposed downstream of the switching gate 76 in the transport direction. The transport roller 78 transports the sheet P transported in the transport direction switched to the other side (upper side of FIG. 3) by the switching gate 76. The second output roller 79 outputs the sheet P transported by the transport roller 78 to the second placement tray 72.

The inversion transport unit 80 includes an inversion transport path 81 beside the fixing device 45. The sheet P is inverted by rotating the transport roller 78 in the opposite direction to the direction in which the transport roller 78 outputs the sheet P to the second placement tray 72 and being transported through the inversion transport path 81. Plural transport rollers 82 are provided along the inversion transport path 81. The sheet P transported by these transport rollers 82 are fed to the second transfer position again by the transport rollers 82.

Furthermore, the image recording device 200 includes a device-body frame 11 and a device housing 12. The device-body frame 11 directly or indirectly supports the image forming section 20, the sheet feed unit 60, the sheet output unit 70, the inversion transport unit 80, and the control device 400. The device housing 12 is attached to the device-body frame 11 so as to form the outer surface of the image forming apparatus 1.

The device-body frame 11 includes a reading-device support 13 on one lateral end side of the image forming apparatus 1. The components such as the switching gate 76, the first output roller 77, the transport roller 78, and the second output roller 79 are disposed in the reading-device support 13. The reading-device support 13 extends in the up-down direction so as to support the image reading device 100. The reading-device support 13 cooperates with a portion of the device-body frame 11 on the rear side for supporting the image reading device 100.

Furthermore, the image recording device 200 includes a front covering 15 as part of the device housing 12. The front covering 15 is provided on the front side of the image forming section 20 and openably attached to the device-body frame 11.

The user is able to replace any of the intermediate transfer unit 30 and the toner cartridges 29Y, 29M, 29C, and 29K of the image forming section 20 with a new one by opening the front covering 15.

The user interface 300 is, for example, a touch panel. With the touch panel used as the user interface 300, various types of information such as image forming conditions of the image forming apparatus 1 are displayed in the touch panel. Also according to the present exemplary embodiment, a list of plural functions relating to the image forming apparatus 1 is displayed in the form of a display image. The user performs input operations for the image forming conditions and so forth by touching the touch panel. Also according to the present exemplary embodiment, the user selects his or her target function from the list. That is, the user interface 300 functions as a display that displays in the form of a display image the list of the plural functions relating to the image forming apparatus 1 in which the user interface 300 is included, and the user interface 300 also functions as an operating unit that accepts a selecting operation in which the user selects a target function from the list. The user interface 300 is not necessarily a touch panel. The functions of the display and the functions of the operating unit may be separated. That is, the user interface 300 may include a display and an operating unit separated from each other. In this case, the display includes a liquid crystal display or the like and the operating unit includes physical buttons or the like.

### Description of the Operations of the Image Forming Apparatus 1

The image forming apparatus 1 having the above-described structure operates as follows.

For example, the user is able to copy an original document by using the image forming apparatus 1. That is, the original document is able to be copied by forming an image on the sheet P with the image recording device 200 in accordance with image data of the original document read by the image reading device 100. Furthermore, the user is able to perform printing by transmitting a print job to the image forming apparatus 1 from a personal computer (PC) or the like (not illustrated) connected to a line of communication. That is, the printing is able to be performed by receiving the print job through the line of communication and forming an image on the sheet P with the image recording device 200 in accordance with image data included in the print job. Furthermore, facsimile communication is usable for the user. That is, image data of an original document read by the image reading device 100 is able to be transmitted through the line of communication. The user is also able to save image data of an original document. That is, the image data of the original document is able to be saved in the image forming apparatus 1 or a PC connected to the line of communication.

Here, operations of the image forming apparatus 1 are described in detail with an example in which the user copies an original or performs printing.

An image of the original document read by the image reading device 100 and image data received from the PC or the like are subjected to predetermined image processing. The image data on which the image processing has been performed is converted into colorant gradation data of the four colors, that is, yellow (Y), magenta (M), cyan (C), and black (K) and output to the optical system unit 50.

In the optical unit 50, the laser light emitted from the semiconductor laser (not illustrated) in accordance with the received color gradation data is directed to the polygon mirror through an f-θ lens (not illustrated). With the polygon mirror, the laser light incident thereupon is modulated in accordance with the gradation data of the colors, deflected and scanned, and radiated to the photosensitive drums 22 of the image forming units 21Y, 21M, 21C, and 21K through an imaging lens (not illustrated) and plural mirrors (not illustrated).

The surfaces of the photosensitive drums 22 of the image forming units 21Y, 21M, 21C, and 21K having been charged by the chargers 23 are exposed to and scanned by the laser light, thereby electrostatic latent images are formed. The electrostatic latent images having been formed are developed into toner images of yellow (Y), magenta (M), cyan (C), and black (K) colors by the respective image forming units 21Y, 21M, 21C, and 21K. The toner images formed on the photosensitive drums 22 of the image forming units 21Y, 21M, 21C, and 21K are transferred onto the intermediate transfer belt 31 serving as an intermediate transfer body through multi-transfer.

Meanwhile, in the sheet feed unit 60, the sheet P contained in one of the sheet containers 61 is picked up by rotating a corresponding one of the feed rollers 62 at timing adjusted to timing of image formation. The picked up sheet P is transported through the transport path 63 by the transport rollers 64 and 65. After that, the transport roller 66 is rotated at timing adjusted to movement timing of the intermediate transfer belt 31 on which the toner images have been formed, thereby transporting the sheet P to the second transfer position formed by the backup roller 35 and the second transfer roller 41. At the second transfer position, the toner images of four colors superposed on one another are transferred in the sub-scanning direction by using a pressure contact force and a predetermined electric field onto the sheet P being transported upward from below. The sheet P onto which the toner images of the colors have been transferred is subjected to a fixing process of heat and pressure performed by the fixing device 45 and then output and placed on the first placement tray 71 or the second placement tray 72.

When duplex printing is requested, the sheet P on one side of which the images have been formed is transported by the inversion transport unit 80 so as to be inverted, and the sheet P is fed again to the second transfer position. At the second transfer position, the toner images are transferred onto the other side of the sheet P, and the transferred images are fixed by the fixing device 45. After that, the sheet P on both the sides of which the toner images have been formed is output and placed on the first placement tray 71 or the second placement tray 72.

The user interface 300 operates as follows.

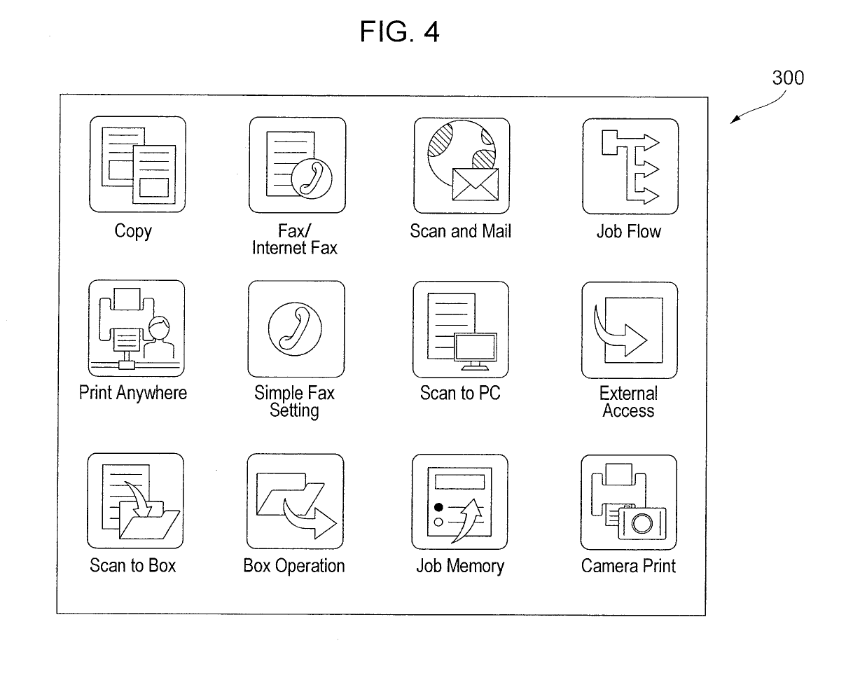

FIG. 4 is an example of a display image displayed in the user interface 300.

As has been described, the display image displayed in the user interface 300 is a list of the plural functions relating to the image forming apparatus 1 in which the user interface 300 is included.

The example of FIG. 4 is the list of the functions displayed in the user interface 300 in a standard state. In this case, the user interface 300 displays icons representing the following functions so as to be watched at a glance: “Copy”, “Fax/Internet Fax”, “Scan and Mail”, “Job Flow”, “Print Anywhere”, “Simple Fax Setting”, “Scan to PC”, “External Access”, “Scan to Box”, “Box Operation”, “Job Memory”, and “Camera Print”.

In order to use a target function, the user performs a selecting operation to select one of the icons.

Specifically, when the user interface 300 is a touch panel, the selecting operation is an operation in which the user touches an icon. However, this is not limiting. When the user interface 300 includes, for example, a liquid crystal display and physical buttons separated from each other, the selecting operation is able to be performed as follows: the user presses down physical arrow buttons to select an icon and similarly presses down a physical determination button.

when the number of functions increases, it is impossible to display all the functions in the user interface 300 at a time. In order to address this, the functions may be displayed, for example, in a hierarchic manner. In this case, the user is able to locate a target function by performing selecting operations sequentially from higher to lower levels of the hierarchy.

In some cases, it is difficult for the user to recognize where the target function exists. In this case, when the hierarchy is deep, it takes time and effort to navigate up and down the hierarchy. When the hierarchy is shallow and the number of functions displayed per screen is increased, the user takes time to find the target function.

According to the present exemplary embodiment, this may be suppressed by controlling with the control device 400 the list of the functions displayed in the user interface 300 as follows. Although the details will be described later, the control device 400 functions as a controller that performs control for displaying in the user interface 300 the list of the functions relating to the position in the line of sight of the user.

### Description of the Control Device 400

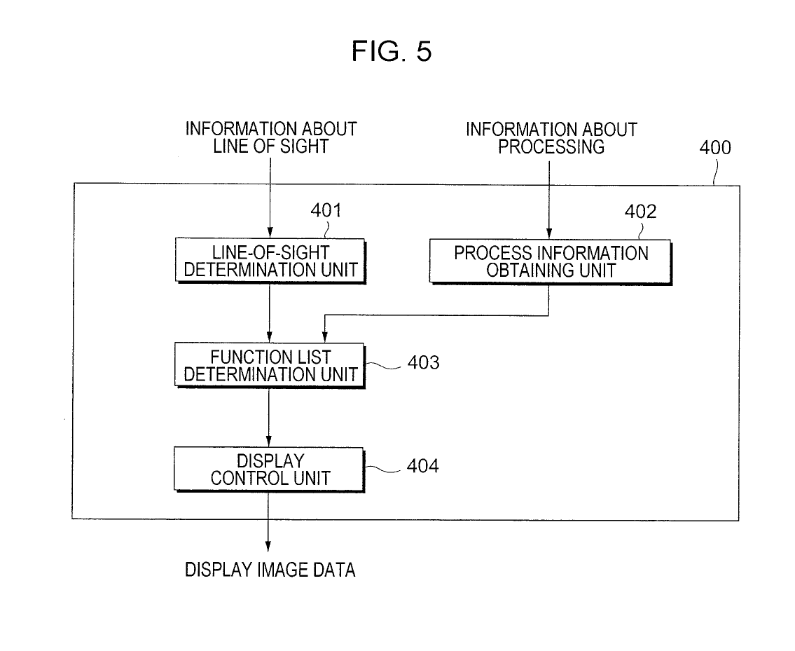

FIG. 5 is a block diagram illustrating an example of a functional configuration of the control device 400. It is noted that, in FIG. 5, functions relating to the present exemplary embodiment are selected and illustrated out of the various functions of the control device 400.

As illustrated in FIG. 5, the control device 400 according to the present exemplary embodiment includes a line-of-sight determination unit 401, a process information obtaining unit 402, a function list determination unit 403, and a display control unit 404. The line-of-sight determination unit 401 determines the line of sight of the user. The process information obtaining unit 402 obtains information about a process performed by the image forming apparatus 1. The function list determination unit 403 determines functions to be displayed in the user interface 300. The display control unit 404 controls the display image displayed in the user interface 300.

The line-of-sight determination unit 401 obtains information about the line of sight of the user detected by the detection device 500 (see FIG. 1). Thus, the line-of-sight determination unit 401 determines what position is watched by the user.

The process information obtaining unit 402 obtains information about a process performed by the image forming apparatus 1 in a present state. For example, when the user transmits in advance a print job from the PC or the like to perform printing by the image forming apparatus 1, information about this process is obtained.

The function list determination unit 403 determines functions to be displayed in the user interface 300 in accordance with the position watched by the user.

The display control unit 404 performs control for displaying in the user interface 300 the list of the functions determined by the function list determination unit 403. Actually, the display control unit 404 generates at a predetermined time interval display image data of the display image to be displayed in the user interface 300 and sequentially outputs the display image data to the user interface 300.

### Description of Operations of the Control Device 400 First Example

Next, a first example of operations of the control device 400 is described.

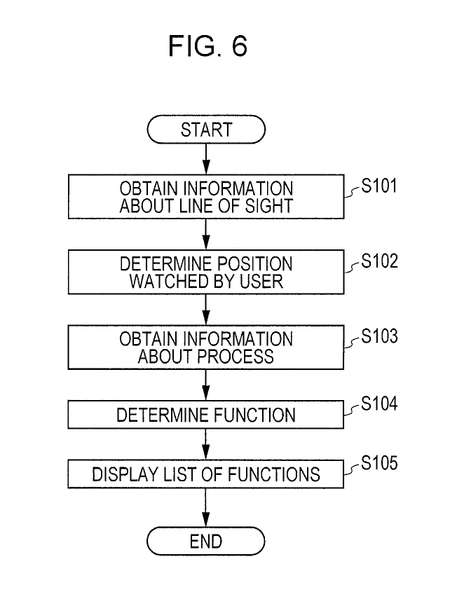

FIG. 6 is a flowchart illustrating the first example of the operations of the control device 400.

First, the line-of-sight determination unit 401 obtains information about the line of sight of the user detected by the detection device 500 (step S101). Furthermore, the line-of-sight determination unit 401 determines the position watched by the user (step S102).

Next, the process information obtaining unit 402 obtains information about a process performed by the image forming apparatus 1 in a present state (step S103).

The function list determination unit 403 determines functions to be displayed in the user interface 300 in accordance with the position watched by the user and the type of the process obtained by the process information obtaining unit 402 (step S104).

The display control unit 404 performs control for displaying in the user interface 300 a list of the functions determined by the function list determination unit 403 (step S105).

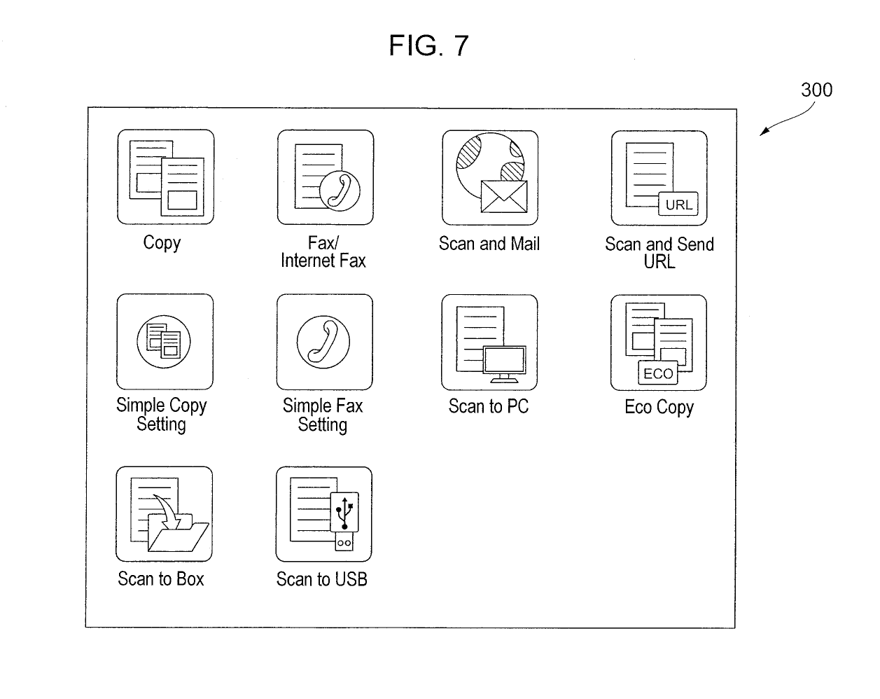

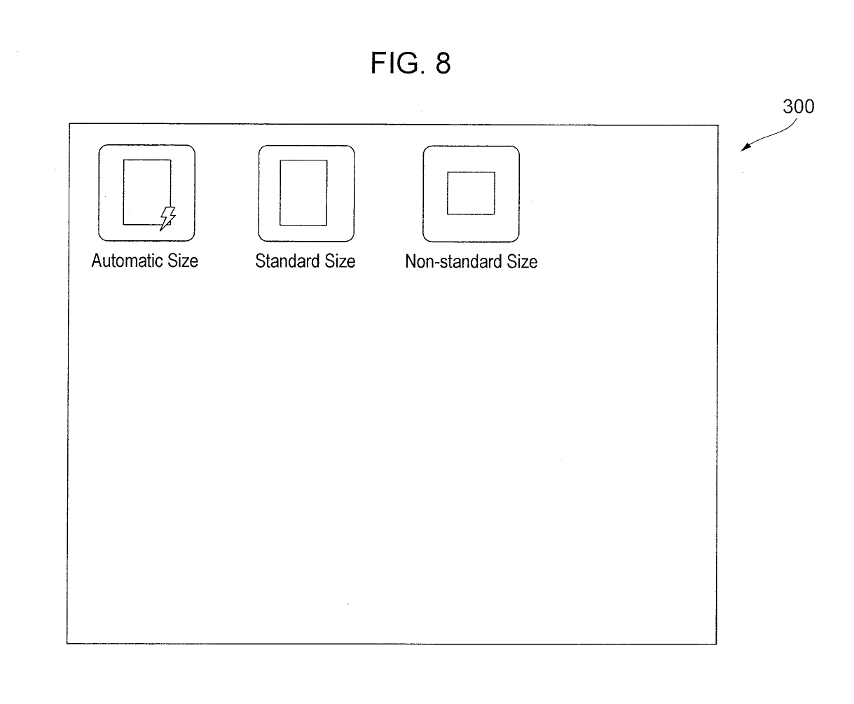

FIGS. 7 and 8 are examples of display images displayed in the user interface 300 according to the first example.

Among these drawings, FIG. 7 illustrates an example of the list of the functions displayed in the user interface 300 when the position watched by the user is the document transport unit 120 (see FIG. 3).

The list of the functions using the document transport unit 120 is displayed by arranging icons in the user interface 300 at this time. Specifically, the user interface 300 displays icons representing the following functions as the list: “Copy”, “Fax/Internet Fax”, “Scan and Mail”, “Scan and Send URL”, “Simple Copy Setting”, “Simple Fax Setting”, “Scan to PC”, “Eco Copy”, “Scan to Box”, and “Scan to USB”. These functions relate to scanning, printing, and facsimile and different from the functions represented by the list of the functions displayed in the standard state of FIG. 4.

FIG. 8 illustrates an example of the list of the functions displayed in the user interface 300 when the position watched by the user is the manual feed tray 67 (see FIG. 3).

The list of the functions relating to manual feed copying is displayed by arranging icons in the user interface 300 at this time. Specifically, the user interface 300 displays icons representing the following sizes as the list: “Automatic Size”, “Standard Size”, and “Non-standard Size”. In this case, instead of the functions relating to the manual feed copying, the way to use the manual feed tray 67 (for example, an instruction on the orientation of the sheet P) may be displayed.

When the position watched by the user is one of the output trays, that is, the first placement tray 71 or the second placement tray 72 (see FIG. 3), it is thought that the user only wishes to collect the sheet P having undergone printing. Accordingly, it is sufficient that the list of the functions to be displayed in the user interface 300 be the list displayed in the standard state of FIG. 4.

The examples of FIGS. 7 and 8 are for the cases where the function list determination unit 403 determines the functions relating to the position in the line of sight of the user and the display control unit 404 displays the list of these functions as the icons in the user interface 300.

In contrast, when a process obtained by the process information obtaining unit 402 is a print job from the user, the functions relating to the print function are displayed regardless of what position is watched by the user. In this case, the function list determination unit 403 determines the functions relating to the process performed in advance by the user and the display control unit 404 displays these functions in the user interface 300.

### Second Example

Next, a second example of the operations of the control device 400 is described.

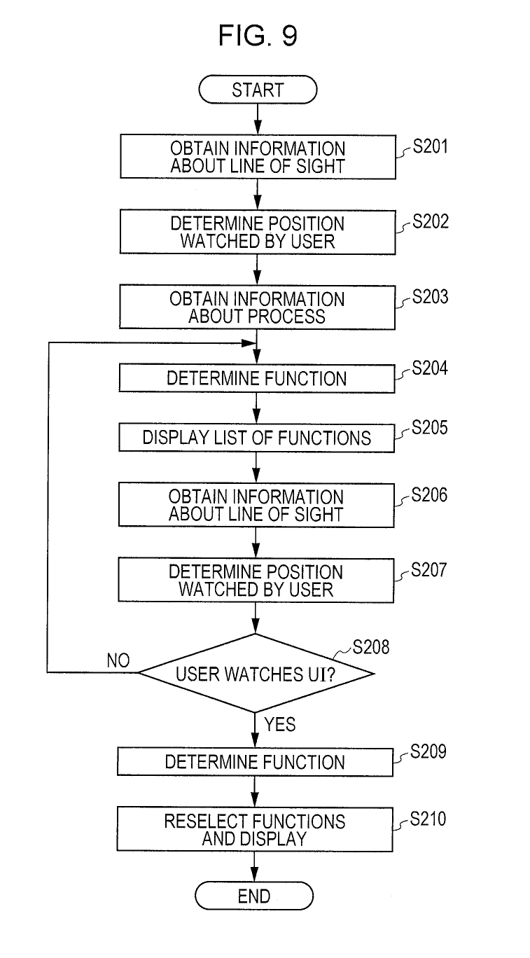

FIG. 9 is a flowchart illustrating the second example of the operations of the control device 400.

Processing from step S201 to step S205 of FIG. 9 is the same as or similar to the processing from step S101 to step S105 of FIG. 6. Thus, description of the processing from step S201 to step S205 is omitted.

After step S205, the line-of-sight determination unit 401 further obtains information about the line of sight of the user detected by the detection device 500 (step S206). The line-of-sight determination unit 401 determines the position watched by the user (step S207).

Next, the line-of-sight determination unit 401 determines whether or not the position watched by the user is the user interface 300 (step S208).

When the position watched by the user is not the user interface 300 (“NO” in step S208), the processing returns to step S204.

In contrast, when the position watched by the user is the user interface 300 (“YES” in step S208), the function list determination unit 403 determines functions in accordance with a function presently displayed at the position in the line of sight of the user toward the user interface 300 (step S209).

The display control unit 404 reselects the functions and displays the reselected functions in the user interface 300 (step S210).

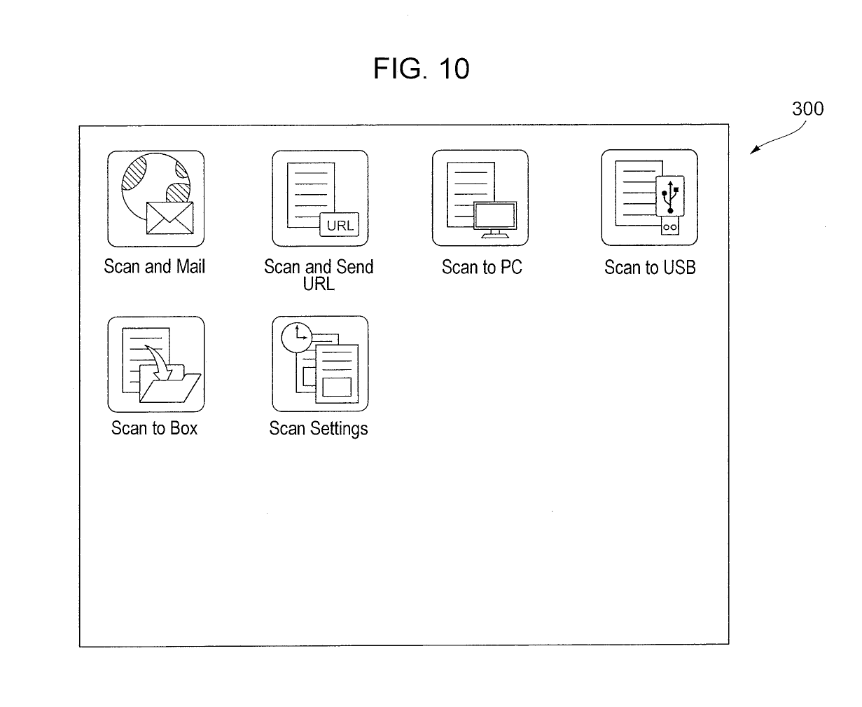

FIG. 10 is an example of a display image displayed in the user interface 300 according to the second example.

FIG. 10 illustrates an example in which the position watched by the user is the user interface 300, and more specifically, the icon of, for example, “Scan and Mail” at the position in step S208 described above.

At this time, as functions in accordance with the function of “Scan and Mail”, the icons of “Scan and Send URL”, “Scan to PC”, “Scan to USB”, Scan to Box”, and “Scan Settings” are displayed in the user interface 300 in addition to “Scan and Mail”.

At this time, a high priority may be assigned to displaying of functions not included in the list of the functions displayed before the reselection. For example, a high priority is assigned to display of functions that are not in the list for the functions displayed in the standard state as illustrated in FIG. 4 and that are found only by navigating down the hierarchy.

According to the above-described exemplary embodiment, changing the list of the functions displayed in the user interface 300 is controlled in accordance with the line of sight of the user. Thus, the user may easily find a target function from the list.

Although the information processing apparatus is exemplified by the image forming apparatus 1 in the above-described examples, this is not limiting. That is, the present exemplary embodiment is applicable to any of apparatuses as long as the apparatuses display a list of plural functions in the form of a display image. For example, the present exemplary embodiment is also applicable to devices such as mobile phones, smart phones, and tablets in which icons of application programs are displayed and arranged as the list of functions.

Furthermore, in the above-described examples, the information processing system S is configured by providing the detection device 500 and the image forming apparatus 1 as the information processing apparatus as separate units. However, for example, the detection device 500 may be disposed in the image forming apparatus 1 so as to be integrated with the image forming apparatus 1.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing apparatus comprising:
a display that displays a list of at least one function; and
a controller that performs control to display in the display a first list of at least one function relating to a position watched by the user, and not to display a second list of at least one function that is not related to the position watched by the user.

2. The information processing apparatus according to claim 1,
wherein the controller causes the first list of the at least one function to include a function or functions relating to a process having been performed in advance by the user.

3. The information processing apparatus according to claim 1,
wherein the controller reselects the at least one function displayed in the display in accordance with a function among the at least one function presently displayed at the position watched by the user toward the display.

4. The information processing apparatus according to claim 3,
wherein the controller assigns a higher priority to displaying the at least one function that is not displayed before the reselection than a priority given to displaying of the at least one function that is displayed before the reselection.

5. An information processing system comprising:
a detector that detects a position watched by the user;
a display that displays a list of at least one function; and
a controller that performs control to display in the display a first list of at least one function relating to the position detected by the detector, and not to display a second list of at least one function that is not related to the position detected by the detector.

6. (canceled)

7. The information processing apparatus according to claim 1, wherein the position watched by the user is not on the display.

8. The information processing apparatus according to claim 1, wherein a high priority is assigned to displaying functions that are not in the displayed list of the at least one function, and are found only by navigating down an hierarchy of the displayed list.

9. An information processing apparatus comprising:
a display that displays a list of at least one function; and
a controller that performs control to display in the display a list of at least one function relating to a function using a portion watched by a user.

10. The information processing apparatus according to claim 9, wherein the portion watched by the user is not on the display.
